(19) United States
(12) Patent Application Publication
(10) Pub. No.: US 2017/0120475 A1
(43) Pub. Date: May 4, 2017

(54) Mould for a Skimmer Box Lid

(71) Applicant: Skimmer Lids Pty Ltd, Southport (AU)

(72) Inventor: William Geoffrey Freeman, Southport (AU)

(21) Appl. No.: 15/336,801

(22) Filed: Oct. 28, 2016

(30) Foreign Application Priority Data
Oct. 28, 2015 (AU) 2015904417

(51) Int. Cl. B28B 7/18; B28B 11/24; E04H 4/14; B28B 1/14

(52) U.S. Cl. CPC B28B 7/18; B28B 1/14; B28B 11/243; E04H 4/14

(57) ABSTRACT

A mould for a skimmer box lid includes a mould body having a floor and a sidewall extending from the floor. The sidewall defines a side of a mould cavity in which a settable material can be received. A slot member projects from the floor and into the mould cavity. The slot member defines a passage with a transverse cross-section that is elongate and has a width of less than 10 mm.

### RELATED APPLICATIONS

The present application claims the benefit of Australian Provisional Patent Application 2015904417 filed on 28 Oct. 2015. The entire contents of Australian Innovation Patent 2014100682 filed on 18 Jun. 2014 are herein incorporated by reference.

### FIELD OF THE INVENTION

Various embodiments of a mould for a skimmer box lid, a skimmer box lid and a method of forming a skimmer box lid are described in this specification.

### BACKGROUND OF THE INVENTION

Skimmer box lids are used to cover or close a skimmer box, weir or drain of a swimming pool or some other water reservoir. They can be removed to provide access to the weir for maintenance, cleaning and the removal or attachment of accessories, such as cleaners and basket filters.

### SUMMARY OF THE INVENTION

In one aspect, there is provided a mould for a skimmer box lid, the mould comprising:

a mould body including a floor and a sidewall extending from the floor, the sidewall defining a side of a mould cavity in which a settable material can be received; and

a slot member that projects from the floor and into the mould cavity, the slot member defining a passage with a transverse cross-section that is elongate and has a width of less than 10 mm.

The slot member and the sidewall may have substantially the same height, measured from the floor.

The floor may be planar and the sidewall may extend from a periphery of the floor.

The floor may span the sidewall so that one side of the mould body is closed.

The slot member may be positioned centrally with respect to the floor. Instead, the slot member may be offset from a centre of the floor.

The floor may have an opening so that the settable material can be introduced into the mould cavity through the opening, with the sidewall positioned against a substrate so that the mould cavity is defined between the floor and the substrate.

The floor may have two openings of substantially the same size with the slot member positioned centrally on part of the floor interposed between the openings. Instead, the floor may have two openings of different sizes with the slot member positioned on part of the floor interposed between the openings so that the slot member is offset with respect to a centre of the mould cavity.

A retaining member may be arranged on the sidewall to extend into the mould cavity.

The mould body may be of a material that has a higher level of resistance to physical damage than the settable material, once set. The mould body may be of steel.

In one aspect there is provided a skimmer box lid that comprises:

a mould that includes:
a mould body including a floor and a sidewall extending from the floor, the sidewall defining a side of a mould cavity in which a settable material can be received; and
a slot member that projects from the floor and into the mould cavity, the slot member defining a passage with a transverse cross-section that is elongate and has a width of less than 10 mm; and a settable material received in the mould cavity.

In one aspect, there is provided a method of forming a skimmer box lid, the method comprising:

pouring a settable material into a mould cavity of a mould that includes

a mould body including a floor and a sidewall extending from the floor, the sidewall defining a side of a mould cavity in which a settable material can be received; and

a slot member that projects from the floor and into the mould cavity, the slot member defining a passage with a transverse cross-section that is elongate and has a width of less than 10 mm; and

allowing the settable material to set.

The method may include the step of removing the mould from the settable material once the settable material has set.

The method may include the steps of:

placing the mould, floor-up, on a substrate; and

pouring the settable material through an opening in the floor and into the mould cavity.

The method may include the step of placing the mould, floor-up, in a further mould with a floor of the further mould defining the substrate.

The slot member may have an elongate profile in a plane parallel to the floor.

At least one retaining member may extend from an internal surface of the sidewall and into the mould cavity. The, or each, retaining member may serve to assist in retaining the settable material, once set, in position in the mould cavity.

The mould may be of a number of suitable materials. For example, the mould may be of metal or of a plastics material. More particularly, but not exclusively, the mould may be of stainless steel.

In one aspect, a method of forming a skimmer box lid comprises:

pouring a settable material into a mould cavity of a mould that includes a floor, a sidewall extending from the floor, and a slot forming member that projects from the floor and into the mould cavity described above; and

allowing the settable material to set.

The method may include pouring a settable material into any of the moulds described above.

The method may include removing the mould from the settable material once the settable material has set. The mould can also be left in place to form part of the lid. In that application, the mould may serve to reinforce the lid.

Broadly, there is provided a skimmer box lid that includes:

a mould that includes
a mould body that is shaped to define a mould cavity into which a settable material can be poured, the mould body including a floor and a sidewall extending from the floor; and
a slot forming member that projects from the floor and into the mould cavity; and

a settable material received in the mould cavity.

### BRIEF DESCRIPTION OF THE DRAWINGS

FIG. 1 shows a view, from above, of an embodiment of a square mould for a skimmer box lid, with a centrally positioned slot member.

FIG. 2 shows a view, from below, of the mould of FIG. 1.

FIG. 3 shows a view, from above, of an embodiment of a square mould for a skimmer box lid, with an offset slot member.

FIG. 4 shows a view, from below, of the mould of FIG. 3.

FIG. 5 shows a view, from above, of an embodiment of a square mould for a skimmer box lid, with a centrally positioned slot member and openings in a floor of the mould.

FIG. 6 shows a view of the mould of FIG. 5 positioned on a substrate or on a floor of an outer mould.

FIG. 7 shows a view, from above, of an embodiment of a square mould for a skimmer box lid, with an offset slot member and openings in a floor of the mould.

FIG. 8 shows a view, from below, of the mould of FIG. 7.

FIG. 9 shows a view, from above, of an embodiment of a circular mould for a skimmer box lid, with a centrally positioned slot member.

FIG. 10 shows a view, from below, of the mould of FIG. 9.

FIG. 11 shows a view, from above, of an embodiment of a circular mould for a skimmer box lid, with an offset slot member.

FIG. 12 shows a view, from below, of the mould of FIG. 11.

FIG. 13 shows a view, from above, of an embodiment of a circular mould for a skimmer box lid, with a centrally positioned slot member and openings in a floor of the mould.

FIG. 14 shows a view, from below, of the mould of FIG. 13.

FIG. 15 shows a view, from above, of an embodiment of a circular mould for a skimmer box lid, with an offset slot member and openings in a floor of the mould.

FIG. 16 shows a view of the mould of FIG. 15 positioned on a substrate or on a floor of a mould.

FIG. 17 shows a view, from above, of an embodiment of a skimmer box lid formed using the mould of FIG. 1.

FIG. 18 shows a view, from below, of an embodiment of a skimmer box lid formed using the mould of FIG. 14.

FIG. 19 shows a view, from below, of an embodiment of a skimmer box lid formed using the mould of FIG. 5 and engaged with a tool for lifting the lid.

FIG. 20 shows a sectioned view of the mould of FIG. 5 used in a method of forming a skimmer box lid, with the mould partially positioned in a further mould.

FIG. 21 shows a sectioned view of the mould of FIG. 5 used in a method of forming a skimmer box lid, with the mould positioned in a further mould.

### DETAILED DESCRIPTION

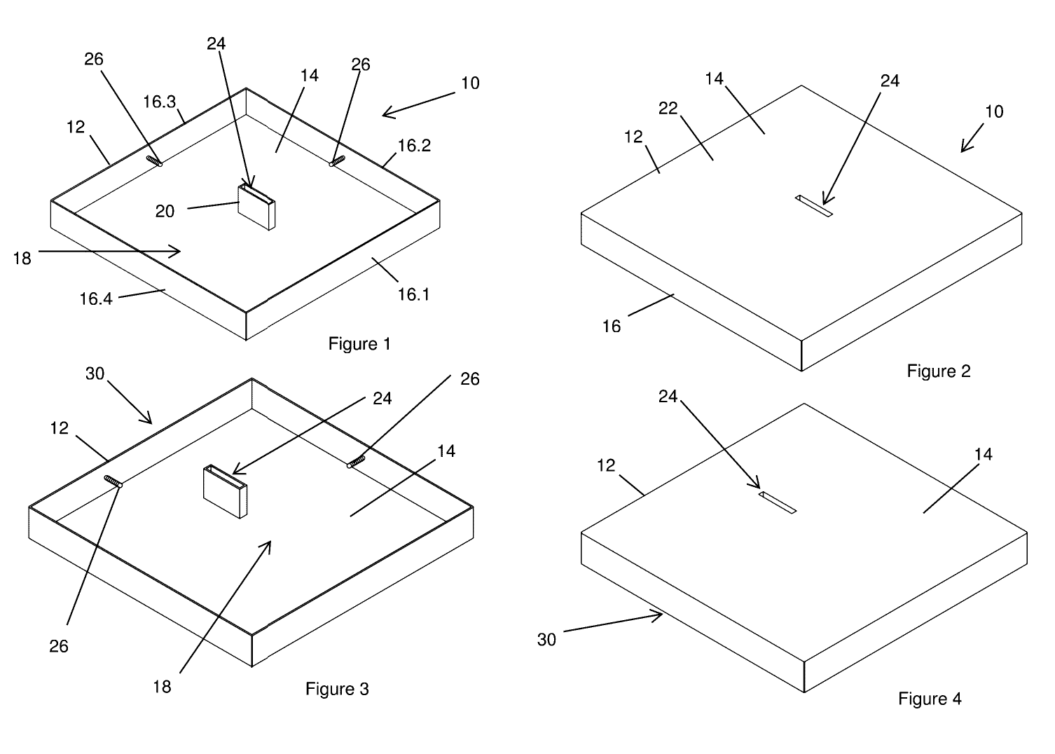

In FIGS. 1 and 2, reference numeral 10 generally indicates an embodiment of a mould for a skimmer box lid. In FIG. 2, reference numeral 10 could also generally indicate a view, from below, of a skimmer box lid formed using the mould. In that case, the mould 10 forms part of the skimmer box lid.

The mould 10 has a mould body 12. The mould body 12 has a floor 14 and a sidewall 16 extending generally orthogonally from a periphery of the floor 14.

The floor 14 is continuous and planar to span the sidewall 16 so that one side of the mould body 12 is closed. The floor 14 is generally square. However, the floor 14 can be a number of different shapes, such as rectangular, hexagonal, et cetera. In such embodiments, the sidewall 16 can have a corresponding shape. The sidewall 16 thus includes four portions 16.1 to 16.4. The floor 14 and the sidewall 16 define a mould cavity 18 into which a settable material can be poured or otherwise received in order to mould or complete the skimmer box lid.

A slot forming member or slot member 20 extends upwardly from the floor 14. In this embodiment, the slot member 20 is centrally positioned on, or with respect to, the floor 14. In those embodiments in which the mould 10 is to be removed, the slot member 20 is the slot forming member and forms the slot in the settable material. In other embodiments in which the mould 10 is to form part of the skimmer box lid, the slot member 20, itself, defines a slot for engagement with an appropriate tool, to lift the skimmer box lid.

The slot member 20 and the sidewall 16 have substantially the same height, measured from the floor 14. Thus, when the mould cavity 18 is filled with the settable material, which is subsequently levelled, upper edges of the sidewall, the settable material and an upper end of the slot member 20 can be flush with each other.

In those embodiments in which the mould is to be removed, the slot member need not have a passage and can simply be in the form of an elongate projection having the appropriate dimensions. Thus, in this case, when the settable material is subsequently levelled, the passage formed in the lid extends all the way through the lid and is formed in the settable material, once set.

The slot member 20 can extend through the floor 14 to an external surface 22 of the floor 14. This can be achieved in a number of ways. For example, the slot member 20 and the floor 14 can be in the form of a unitary, one-piece construction such as a moulding, casting or a machined product. Alternatively, the slot member 20 can be fixed to the floor, for example, by welding.

The slot member 20 is tubular and defines an open passage 24. The passage 24 is configured to suit a key or tool that has a T piece extending from a handle. The T piece is manipulated so that it can be inserted through the passage 24 and subsequently twisted so that a head of the T piece can engage the lid formed in the mould, so that the lid can either be tilted or lifted using the key or tool. An example of a suitable tool is described in the Australian Innovation Patent referenced above and incorporated herein. It is envisaged that other forms of tools could be used for insertion into the passage 24, manipulation and subsequent lifting of the skimmer box lid.

In those embodiments in which the slot member 20 is fixed to the floor 14, the passage 24 can be aligned with a slotted opening defined in the floor 14. It is also envisaged that the slot member 20 can define recesses or other engagement formations that can engage the key or tool to allow the lid to be lifted without necessarily having to insert the tool or key all the way through the slot member 20.

The slot member 20 is also dimensioned so that the passage 24, or the subsequent slot left once the mould is removed, is narrow enough to inhibit the insertion of a child's finger(s) into the slot.

Thus, the passage 24 has a transverse cross-section that is elongate and has a width of less than 10 mm. The elongate, transverse cross-section can have a width of about 7 mm and a length of about 50 mm. It will be appreciated that the length can vary depending on the dimensions of the tool that is to be used to lift the skimmer lid.

Overall, the slot member 20 has an elongate profile in a plane parallel to the floor 14.

A retaining member in the form of a bar or rod 26 or some other form of projection is arranged on two of the sidewall portions 16.2, 16.3. The rods 26 extend into the mould cavity 18. In use, when the settable material is poured into the mould cavity 18 and allowed to set, the rods 26 help to retain the settable material or mixture in position in the mould cavity 18.

Once the material has been poured, it can be levelled so that the passage 24 is accessible from both sides of the resultant skimmer box lid.

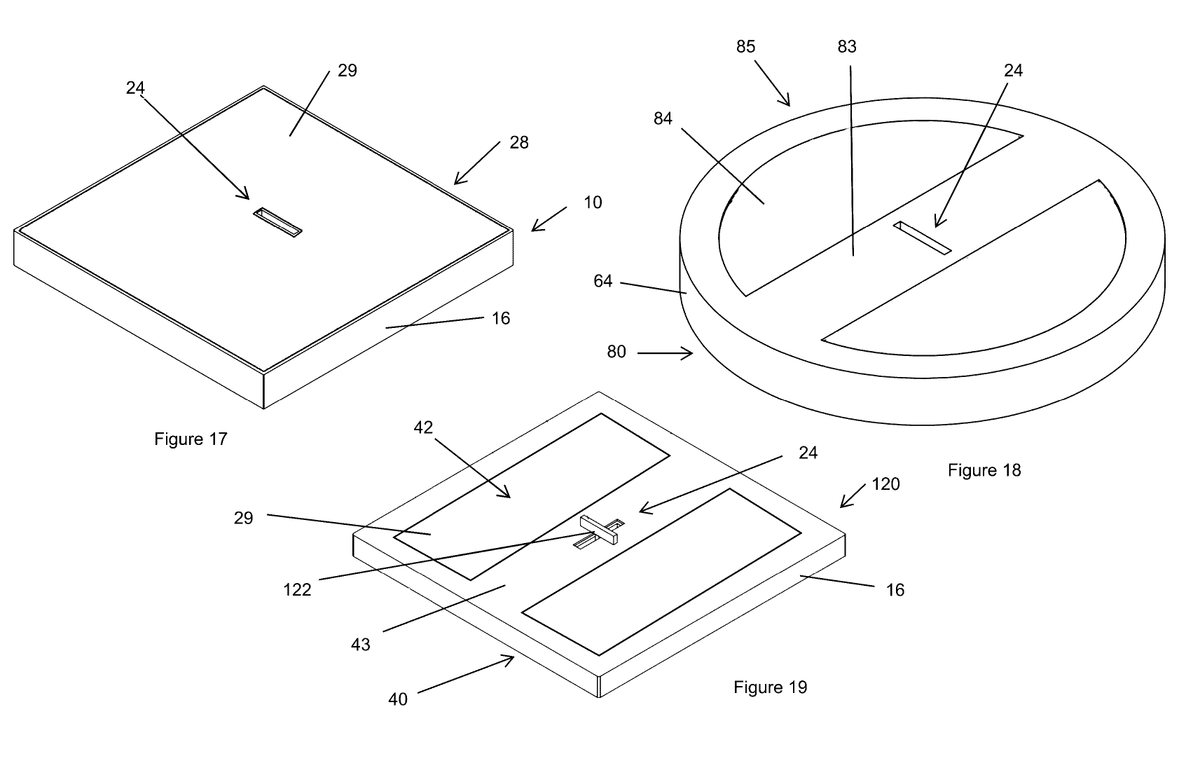

Once the material has set, a lid 28, such as that shown in FIG. 17, is formed. As can be seen, the lid 28 includes the mould 10 and the material indicated at 29. The material 29 can then be surface-finished with a suitable pattern and/or coating. For example, when the settable material is concrete, the finish can be one of those that are currently used to enhance the appearance of concrete. In one example, the concrete can be coloured. Other examples of a settable material are mortar and minerals that are bound with a suitable binder such as epoxy or polyurethane. The material 29 can be selected to have a colour and texture that corresponds with the colour and texture of tiles used in proximity to the lid 28. For example, the material 29 can be pre-selected to suit any of a range of various standard forms of tile. This allows the lid 28 to blend into the surrounding environment so as not to be aesthetically jarring.

In FIGS. 3 and 4, reference numeral 30 generally indicates an exemplary embodiment of a mould for a skimmer box lid.

The mould 30 differs from the mould 10 in the position of the slot member 20. In this embodiment, the slot member 20 is offset from a centre of the floor 14. With an offset slot in the lid, the lid can be tilted with the tool rather than having to be lifted with the tool. For example, the lid can be tilted for inspection or for allowing a user to grasp the lid and remove it.

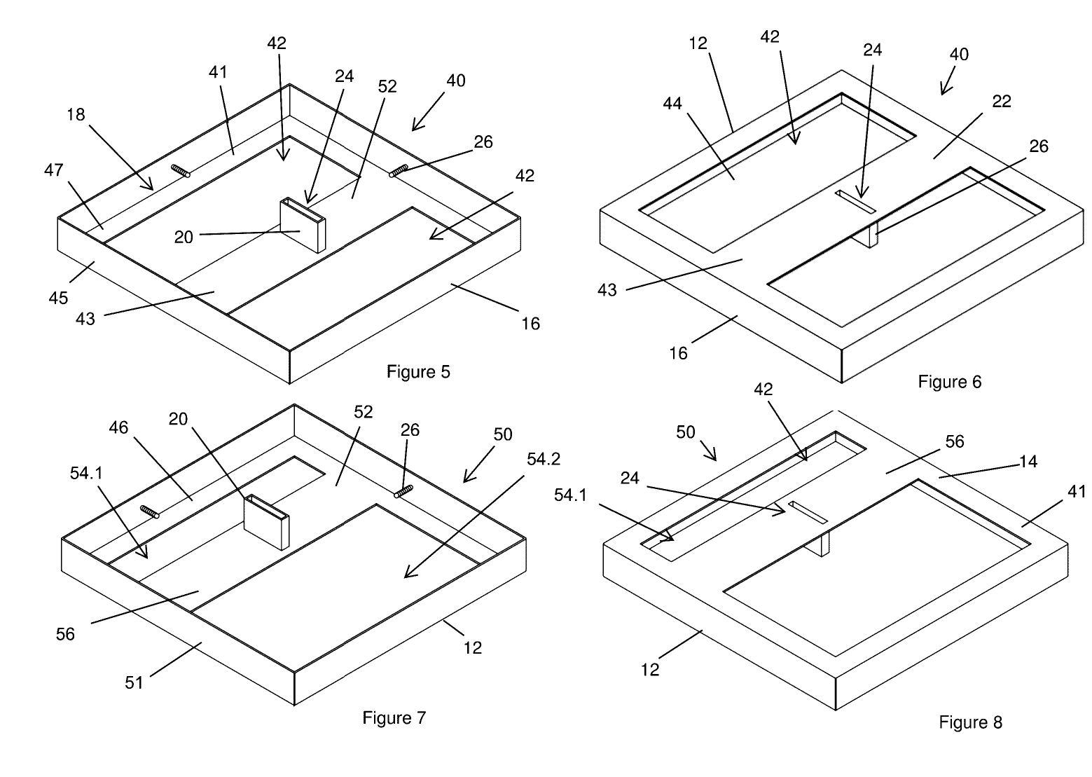

In FIGS. 5 and 6, reference numeral 40 generally indicates an embodiment of a mould for a skimmer box lid.

A mould body 45 has a floor 41 with an opening so that the settable material can be introduced into the mould cavity 18 through the opening, with the sidewall 16 positioned against a substrate so that the mould cavity 18 is defined between the floor 41 and the substrate.

The floor 41 has two openings 42. The slot member 20 is centrally positioned on a part 43 of the floor 14 interposed between the openings 42. In this embodiment, the openings 42 are rectangular and have substantially the same dimensions. Thus, the part 43 extends centrally between opposed portions of the sidewall 16.

In use, the mould 40 is positioned on a surface 44 of a substrate or of a further mould, such as a concrete mould, in the position shown in FIG. 6. The settable material is then poured through the openings 42 to fill the mould cavity 18. Once the material has set, the rods 26 retain the set material in the mould cavity 18. The surface 44 is planar such that the set material and the surface 22 are coplanar.

The openings 42 are dimensioned so that a rim 46 extends inwardly from the sidewall 16. Once the material 29 has set, the material can be supported by the rim 46 in addition to the rods 26.

In FIGS. 7 and 8, reference numeral 50 generally indicates an embodiment of a mould for a skimmer box lid.

The mould 50 has mould body 51 with a floor 52. The floor 52 has two openings, 54.1 and 54.2, the opening 54.1 being smaller than the opening 54.2. Each of the openings 54 are rectangular and define the rim 46. Thus, the floor 52 has a part 56 that is offset to one side, relative to the centre of an area bound by the sidewall 16.

The slot member 20 is positioned on the part 56 so that it is also offset to one side, relative to the centre of an area bound by the sidewall 16.

The use of the mould 50 is the same as that described above with reference to the mould 30. The purpose of the offset, in the formed skimmer box lid, is the same as that described with reference to the mould 30.

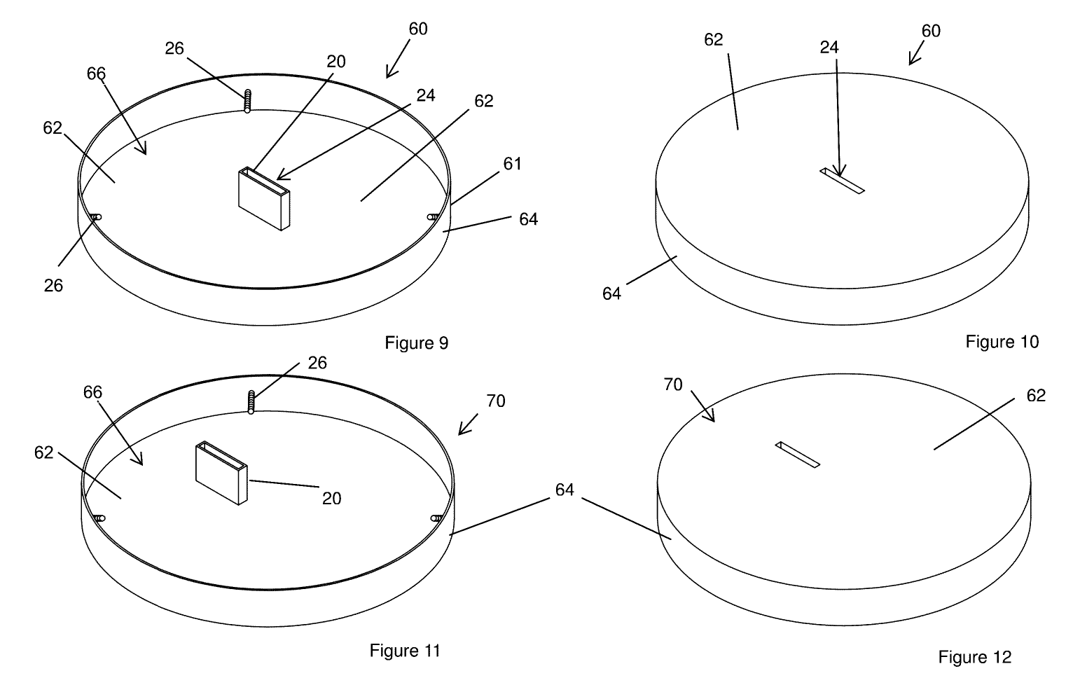

In FIGS. 9 and 10, reference numeral 60 generally indicates an embodiment of a mould for a skimmer box lid.

The mould 60 includes a mould body 61 having floor 62 that is planar, continuous and circular in plan view. The floor 62 thus closes one side of the mould body 61.

A sidewall 64 extends from a periphery of the floor 62. The sidewall 64 defines a side of a mould cavity 66 in which a settable material can be received.

The slot member 20 is centrally positioned in or on the floor 62.

The mould 60 can be used for making circular skimmer box lids in the same manner as that described with reference to the mould 10.

In this embodiment, there is provided three of the rods 26, equally spaced about the sidewall 64.

In FIGS. 11 and 12, reference numeral 70 generally indicates an embodiment of a mould for a skimmer box lid.

In this embodiment, the slot member 20 is offset. The use of this is described above with reference to the mould 30.

The mould 70 can be used for making circular skimmer box lids in the same manner as that described with reference to the mould 30.

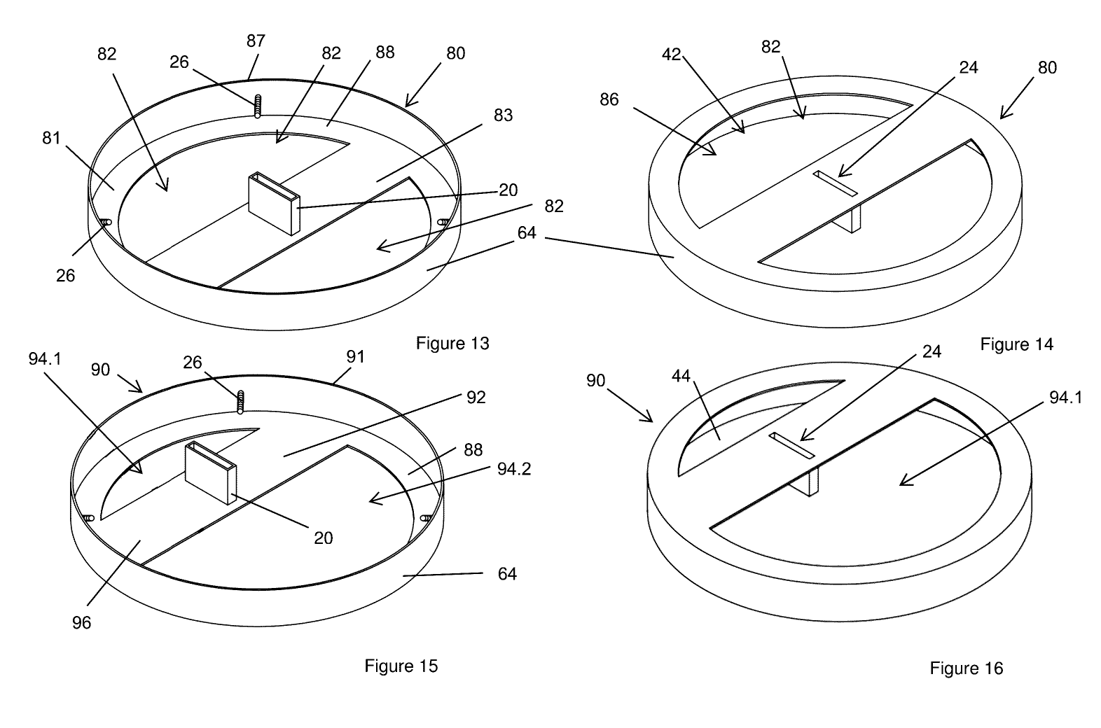

In FIGS. 13 and 14, reference numeral 80 generally indicates an embodiment of a mould for a skimmer box lid.

The mould 80 includes a mould body 87 having a floor 81, with the sidewall 64 extending from a periphery of the floor 81 and defining a side of a mould cavity 86. The floor 81 defines two openings 82. The openings 82 have substantially the same dimensions and are each part-circular. Thus, a part 83 extends diametrically within an area defined by the mould cavity 86. The slot member 20 is centrally positioned on the part 83.

Furthermore, the openings 82 are dimensioned so that a rim 88 extends inwardly from the sidewall 64. The rim 88 serves the same purpose as the rim 46.

The mould 80 is used in the same way as is the mould 40. In FIG. 18, there is shown the mould 80, from below, filled with the settable material, indicated at 84, to form a skimmer box lid 85.

In FIGS. 15 and 16, reference numeral 90 generally indicates an exemplary embodiment of a mould for a skimmer box lid.

The mould 90 has a mould body 91 with a floor 92. The floor 92 has two openings, 94.1 and 94.2, the opening 94.1 being smaller than the opening 94.2. Each of the openings 94 are part-circular and define the rim 88. Thus, the floor 92 has a part 96 that is offset to one side, relative to the centre of an area bound by the sidewall 64.

In this embodiment, the slot member 20 is positioned on the part 96 so that it is also offset to one side, relative to the centre of an area bound by the sidewall 64. Again, the use of this is described above with reference to the mould 30.

In FIG. 19, there is shown a skimmer box lid 120 that incorporates the mould 40. As with the lids 28, 85, the skimmer box lid 120 retains the mould 40.

An engagement formation 122 of a tool is shown extended through the slot 24 and twisted, generally at right angles to the slots 24 to engage an outer surface of the part 43.

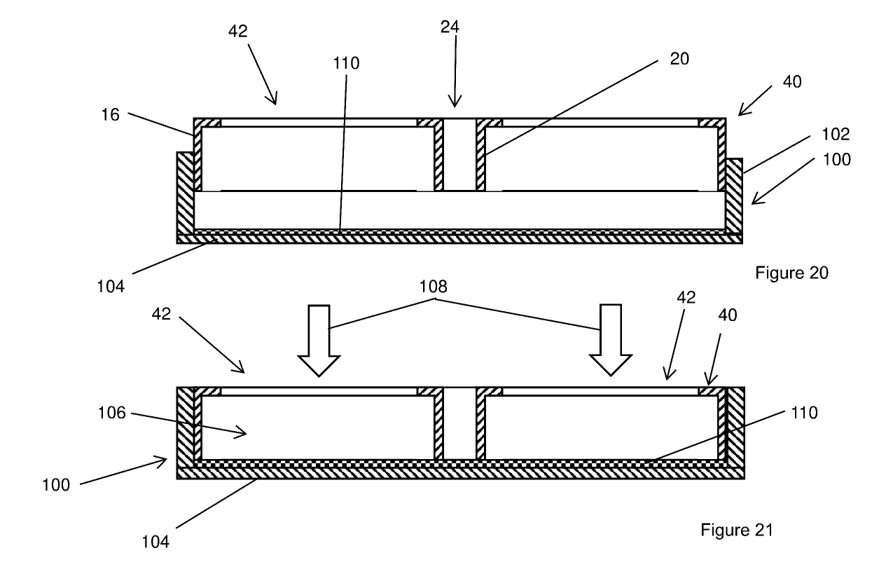

In FIGS. 20 and 21 there is shown the mould 40 of FIGS. 5 and 6 used in a method or process for forming a skimmer box lid.

In the method or process, the mould 40 is inserted into an outer mould 100. The sidewalls 16 can be a sliding fit within sidewalls 102 of the outer mould 100. The mould 40 is inserted into the outer mould 100 to bear against a floor 104 of the outer mould 100.

In that condition, the settable material can be poured through the openings, as indicated by arrows 108, into a mould cavity 106 defined by the moulds 40, 100. The settable material is allowed to set and the mould 40, now forming part of a skimmer box lid, is removed from the outer mould 100.

The floor 104 can be textured, as indicated at 110, with a suitable pattern that is imparted to the upper surface of the skimmer box lid.

The outer mould 100 can be provided together with any of the moulds described above to form a mould assembly, which is to be considered as described herein. Thus, a number of different moulds can be used with one outer mould, selected to achieve a particular texture. Alternatively, either one of the moulds described herein can be used with any number of different outer moulds.

The moulds and the method described above can be used to form skimmer box lids in a cost-effective and highly customisable manner. For example, since the lids are moulded, it is not necessary for any stone to be cut, which is time-consuming and can create a high level of unwanted dust, particularly when carried out in situ. In one possible application, the moulds can be supplied to tile manufacturers who can use the mould in conjunction with their existing tile moulds, as the outer mould, to carry out the process described with reference to FIGS. 20 and 21. In that way, the resultant lid is of a size that complements the size of the tiles with which it is to be used. For example, as can be seen in FIGS. 20 and 21, the sidewalls 16 and 102 can have a thickness that is selected to provide a suitable gap between the tiles and the lid.

An accurate colour match to existing tiles in a pool area can be achieved by using a suitable dye together with the settable material. This facilitates retrofitting of an existing pool area with a colour-matched lid.

The settable material can be a variety of types. For example, the settable material may be a cementitious material, such as concrete. In one example, the concrete can be coloured. Other examples of a settable material are mortar and minerals that are bound with a suitable binder such as epoxy or polyurethane.

Many pool areas have skimmer box lids that are of a plastics or metal material that is distinct from the tiles used in the pool area. The mould provides a means whereby a material can be obtained that, when set, is similar in appearance to the tiles used in the pool area. This can alleviate the visually jarring effect or discordance created by conventional skimmer box lids that do not have the same appearance as the surrounding environment, such as that set up by adjacent tiles.

This aesthetic enhancement is amplified by the dimensions of the slot 24. The slot 24 is less visually discernible than other types of openings, such as finger openings. The reason for this is that the slot 24 is relatively narrow compared with finger openings. In fact, the slot 24, from a distance, may not be readily discernible. This can enhance the visual appearance of an area in which the associated skimmer box is located.

The mould body can be of any number of different materials. These materials can be selected to have a resistance to physical damage which is higher than a resistance to physical damage than the settable material, once set. This has a number of uses. For example, the sidewall and the floor together can inhibit damage to the settable material which may be relatively brittle or frangible when compared with the material of the mould body. It will be appreciated that, in use, over time, the lid will be lifted up and placed on various surfaces. As a result, without any protection, the settable material could become damaged over time. For example, this could include chipping to corners which could negatively impact the aesthetic appearance of the skimmer box lid.

Furthermore, the fact that the engagement portion 122 bears against the material of the mould body protects the settable material from damage that could result from the engagement portion 122 repeatedly digging into the settable material.

The mould body can be of steel. For example, the mould body can be of a stainless steel selected to be weather resistant. In various embodiments, the mould body can be fabricated from steel plate. The steel plate can be between about 1 mm and 3 mm thick. For example, the steel plate can be about 2 mm thick.

In other embodiments, the mould body can be fabricated of other materials, such as a plastics material or other forms of metal. The mould body can be itself moulded or can be cast or machined.

The mould body may have a variety of shapes. For example, the mould body can be rectangular or square or circular in plan view. In other examples, the mould body can have other shapes, such as hexagonal or octagonal, in plan view.

It is to be understood that in various embodiments the mould is not detached from the settable material. This is not to be understood as detracting from the role of the mould, which is to be used to mould the settable material into a desire shape.

The appended claims are to be considered as incorporated into the above description.

In the above description, like reference numerals refer to like parts, unless otherwise specified. It follows that parts of embodiments can be interchanged, where reasonably feasible. The use of common reference numerals is not to be regarded as an indication that any components of one embodiment are essential for another embodiment and is for convenience only.

Throughout the specification, including the claims, where the context permits, the term “comprising” and variants thereof such as “comprise” or “comprises” are to be interpreted as including the stated integer or integers without necessarily excluding any other integers.

When any number or range is described herein, unless clearly stated otherwise, that number or range is approximate. Recitation of ranges of values are to be considered as reciting, individually, each separate value falling within the range, unless otherwise indicated herein.

Words indicating direction or orientation are used for convenience. The inventor(s) envisages that various embodiments can be used in a non-operative configuration, such as when presented for sale. Thus, such words are to be regarded as illustrative in nature, and not as restrictive.

1. A mould for a skimmer box lid, the mould comprising:
a mould body including a floor and a sidewall extending from the floor, the sidewall defining a side of a mould cavity in which a settable material can be received; and
a slot member that projects from the floor and into the mould cavity, the slot member defining a passage with a transverse cross-section that is elongate and has a width of less than 10 mm.

2. The mould as claimed in claim 1, in which the slot member and the sidewall have substantially the same height, measured from the floor.

3. The mould as claimed in claim 1, in which the floor is planar and the sidewall extends from a periphery of the floor.

4. The mould as claimed in claim 3, in which the floor spans the sidewall so that one side of the mould body is closed.

5. The mould as claimed in claim 4, in which the slot member is positioned centrally with respect to the floor.

6. The mould as claimed in claim 4, in which the slot member is offset from a centre of the floor.

7. The mould as claimed in claim 1, in which the floor has an opening so that the settable material can be introduced into the mould cavity through the opening, with the sidewall positioned against a substrate so that the mould cavity is defined between the floor and the substrate.

8. The mould as claimed in claim 7, in which the floor has two openings of substantially the same size with the slot member positioned centrally on part of the floor interposed between the openings.

9. The mould as claimed in claim 7, in which the floor has two openings of different sizes with the slot member positioned on part of the floor interposed between the openings so that the slot member is offset with respect to a centre of the mould cavity.

10. The mould as claimed in claim 1, in which a retaining member is arranged on the sidewall to extend into the mould cavity.

11. The mould as claimed in claim 1, in which the mould body is of a material that has a higher level of resistance to physical damage than the settable material, once set.

12. The mould as claimed in claim 11, in which the mould body is of steel.

13. A skimmer box lid that comprises:
a mould that includes
a mould body including a floor and a sidewall extending from the floor, the sidewall defining a side of a mould cavity in which a settable material can be received; and
a slot member that projects from the floor and into the mould cavity, the slot member defining a passage with a transverse cross-section that is elongate and has a width of less than 10 mm; and
a settable material received in the mould cavity.

14. A method of forming a skimmer box lid, the method comprising:
pouring a settable material into a mould cavity of a mould that includes
a mould body including a floor and a sidewall extending from the floor, the sidewall defining a side of a mould cavity in which a settable material can be received; and
a slot member that projects from the floor and into the mould cavity, the slot member defining a passage with a transverse cross-section that is elongate and has a width of less than 10 mm; and
allowing the settable material to set.

15. The method as claimed in claim 12, which includes the step of removing the mould from the settable material once the settable material has set.

16. The method as claimed in claim 12, which includes the steps of:
placing the mould, floor-up, on a substrate; and
pouring the settable material through an opening in the floor and into the mould cavity.

17. The method as claimed in claim 14, which includes the step of placing the mould, floor-up in a further mould with a floor of the further mould defining the substrate.
